(19) United States
(12) Patent Application Publication
(10) Pub. No.: US 2025/0080265 A1
(43) Pub. Date: Mar. 6, 2025

(54) OPTICAL FILTER ARCHITECTURE

(71) Applicant: Telefonaktiebolaget LM Ericsson (publ), Stockholm (SE)

(72) Inventors: Sergio MOSTI, Genova (IT); Alberto DEHO, Genova (IT); Roberto MAGRI, Genova (IT); Claudio D'INCÀ, Genova (IT)

(21) Appl. No.: 18/290,746

(22) PCT Filed: Jul. 23, 2021
(86) PCT No.: PCT/EP2021/070726

§ 371 Date: Jan. 19, 2024

(51) Int. Cl. H04J 14/02; G02B 6/42; H04B 10/40

(52) U.S. Cl. CPC H04J 14/03; G02B 6/4215; H04B 10/40

(57) ABSTRACT

There is provided an optical filter module comprising a photodetector, a transmitting-side tunable optical filter, and processing circuitry. The photodetector is configured to receive a low speed overlay signal from a transceiver of a fixed wavelength, and wherein the processing circuitry is configured to decode information relating to the fixed wavelength from the low speed overlay signal and set the transmitting-side tunable optical filter at the fixed wavelength.

### TECHNICAL FIELD

The present disclosure relates to the field of optical filters, specifically optical filter architecture and its components. Specifically, the present disclosure relates to components of an optical communication system, as well as methods for enabling and/or performing self-tuning at the components of the optical communication system.

### BACKGROUND

Currently available technologies used in fronthaul network and in low cost metro networks are based on the use of fixed Dense Wavelength Division Multiplexing (DWDM) optical filters that require manual optical connection through optical patch cords, or are based on the use of tunable filters that are managed by a Network Manager that selects channels based on predetermined bandwidth allocations.

A solution is therefore required to improve network flexibility.

### SUMMARY

One aspect of the present disclosure provides an optical filter module comprising a photodetector, a tunable optical filter, and processing circuitry. The photodetector is configured to receive a low speed overlay signal from a transceiver (or in general, an optical pluggable module) of a fixed wavelength, and the processing circuitry is configured to decode information relating to the fixed wavelength from the low speed overlay signal and set the optical filter at the fixed wavelength.

Another aspect of the present disclosure provides a main unit for communication with a remote unit in an optical communication system. The main unit comprises one or more optical filter modules as described herein, wherein each of the one or more optical filter modules includes a transmitting-side tunable optical filter, and one or more transceivers, wherein each of the one or more transceivers is of a fixed wavelength, and each of the one or more transceivers corresponds to a respective optical filter module.

Another aspect of the present disclosure provides a method for enabling self-tuning at an optical filter module, wherein the optical filter module comprises a photodetector, a tunable optical filter, and processing circuitry. The method comprises: receiving, by the photodetector, a low speed overlay signal from a transceiver of a fixed wavelength, decoding, by the processing circuitry, information relating to the fixed wavelength from the low speed overlay signal, and setting, by the processing circuitry, the tunable optical filter at the fixed wavelength.

Another aspect of the present disclosure provides a remote unit for communication with a main unit in an optical communication system. The remote unit comprises: one or more receiving-side tunable optical filters, one or more transceivers, wherein each of the one or more transceivers is of a fixed wavelength, and each of the one or more transceivers corresponds to a respective receiving-side tunable optical filter, a photodetector configured to receive a low speed overlay signal, and processing circuitry configured to decode information relating to the fixed wavelength from the low speed overlay signal and set the one or more receiving-side tunable optical filters at the fixed wavelength.

Another aspect of the present disclosure provides an optical communication system comprising a main unit and a remote unit. The main unit comprises: a plurality of transmitting-side transceivers, wherein each transmitting-side transceiver is of a fixed wavelength and is configured to enable an overlay channel while respective overlay channels at other transmitting-side transceivers are disabled, a plurality of transmitting-side tunable optical filters each corresponding to a transmitting-side transceiver, and a plurality of photodetectors each corresponding to a transmitting-side transceiver, wherein each photodetector is configured to receive a low speed overlay signal from a corresponding transmitting-side transceiver, and a plurality of processing circuitries each corresponding to a transmitting-side tunable optical filter, wherein each processing circuitry is configured to decode information relating to the corresponding fixed wavelength from the low speed overlay signal and to set a corresponding transmitting-side tunable optical filter at the corresponding fixed wavelength. The remote unit comprises: a plurality of receiving-side transceivers, wherein each receiving-side transceiver corresponds to a transmitting-side transceiver of the main unit, a plurality of receiving-side tunable optical filters each corresponding to a receiving-side transceiver, and a photodetector configured to receive a corresponding low speed overlay signal, and processing circuitry configured to decode the information relating to the corresponding fixed wavelength from the low speed overlay signal and set a receiving-side tunable optical filter corresponding to the respective transmitting-side transceiver at the corresponding fixed wavelength.

Another aspect of the present disclosure provides a method for enabling self-tuning at an optical communication system, wherein the optical communication system comprises a main unit and a remote unit, wherein the main unit comprises a plurality of transmitting-side transceivers each of a fixed wavelength, a plurality of transmitting-side tunable optical filters each corresponding to a transmitting-side transceiver, a plurality of photodetectors each corresponding to a transmitting-side transceiver, and a plurality of processing circuitries each corresponding to a transmitting-side tunable optical filter, wherein the remote unit comprises a plurality of receiving-side transceivers each corresponding to a transmitting-side transceiver of the main unit, a plurality of receiving-side tunable optical filters each corresponding to a receiving-side transceiver, a photodetector, and a driving circuit. The method comprises: enabling an overlay channel at a first transmitting-side transceiver of the plurality of transmitting-side transceivers for transmission of signals not involving time-division multiplexing or frequency-division multiplexing, while keeping respective overlay channels at other transmitting-side transceivers disabled; receiving, at a first photodetector of the main unit which corresponds to the first transmitting-side transceiver, a low speed overlay signal from the first transmitting-side transceiver; decoding, by a first processing circuitry of the main unit which corresponds to the first transmitting-side tunable optical filter, information relating to the fixed wavelength from the low speed overlay signal; setting, by the first processing circuitry of the main unit, the first transmitting-side tunable optical filter at the fixed wavelength; receiving, by the photodetector of the remote unit, the low speed overlay signal; decoding, by the processing circuitry of the remote unit, information relating to the fixed wavelength from the low speed overlay signal; and setting, by the processing circuitry of the remote unit, a first receiving-side tunable optical filter at the fixed wavelength.

Another aspect of the present disclosure provides a method for enabling self-tuning at an optical communication. The optical communication system comprises a main unit and a remote unit, wherein the main unit comprises a main host unit and a plurality of transmitting-side transceivers each of a fixed wavelength, and wherein the remote unit comprises a remote host unit, a plurality of receiving-side transceivers, a plurality of receiving-side tunable optical filters, a plurality of transmitting-side photodetectors, and a processing circuitry. The method comprises: generating, by the main host unit, an initial table comprising information relating to the cross-connections between a plurality of transmitting-side transceiver ports and a plurality of receiving-side transceiver ports, wherein each of the plurality of transmitting-side transceiver ports corresponds to a respective one of the plurality of transmitting-side transceivers, and each of the plurality of receiving-side transceiver ports corresponds to a respective one of the plurality of receiving-side transceivers, transmitting a low speed signal from the main host to the plurality of transmitting-side photodetectors of the remote unit, wherein the low speed signal includes the initial table, detecting, by the plurality of transmitting-side photodetectors of the remote unit, a correspondence between each of the plurality of receiving-side optical filters and a respective one of the plurality of receiving-side transceivers, generating, by the processing circuitry of the remote unit, an updated table based on the initial table, wherein the updated table further comprises information that corresponds at least one of the fixed wavelengths and the ports of the plurality of transmitting-side transceivers with receiving-side tunable optical filters corresponding to respective receiving-side transceivers, and setting, by the processing circuitry of the remote unit, each of the plurality of receiving-side tunable optical filters at respective fixed wavelengths based on the updated table.

### BRIEF DESCRIPTION OF THE DRAWINGS

For a better understanding of examples of the present disclosure, and to show more clearly how the examples may be carried into effect, reference will now be made, by way of example only, to the following drawings in which:

FIG. 1 is a block diagram illustrating fixed Small Form-Factor Pluggable (SFP) transceiver with a low speed overlay coder/decoder;

FIG. 2 is a block diagram of a main unit according to embodiments of the disclosure;

FIG. 3 is a block diagram of a remote unit according to embodiments of the disclosure;

FIG. 4 is a block diagram of an optical communication system according to embodiments of the disclosure;

FIG. 5 is a block diagram of an optical communication system according to embodiments of the disclosure;

FIG. 6 is a flowchart illustrating a method at an optical filter module, according to embodiments of the disclosure;

FIG. 7 is a flowchart illustrating a method at an optical communication system, according to embodiments of the disclosure; and

FIG. 8 is a flowchart illustrating a method at an optical communication system, according to embodiments of the disclosure.

### DETAILED DESCRIPTION

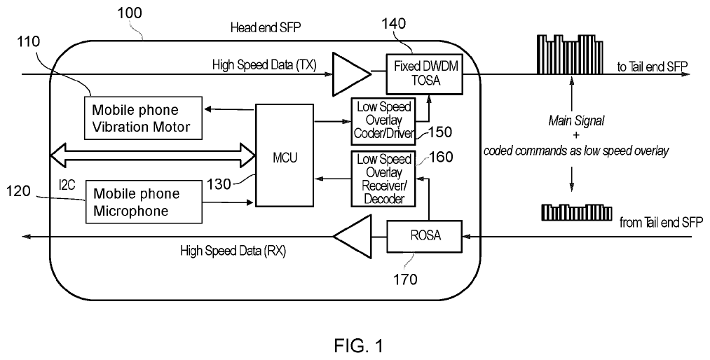

FIG. 1 is a block diagram illustrating Fixed SFP DWDM transceiver with a low speed overlay coder/decoder. In FIG. 1, there is provided a head end SFP transceiver 100 including a microcontroller unit 130, a fixed DWDM transmitter optical sub-assembly (TOSA) 140, a low speed overlay coder/driver 150, a second low speed overlay receiver/decoder 160, and a receiver optical sub-assembly (ROSA) 170. For transmission, the TOSA 140 combines (multiplexes) the high speed data signal (channel) with low speed overlay signal, and outputs a single optical signal. For receiving, the ROSA 170 demultiplexes the received optical signal into a data signal (channel) and an overlay signal. The overlay signals are received by, or controlled by the microcontroller 130. In some aspects, the microcontroller 130 is connected to one or more tunable filters, described below, in order to match the operational frequency (channel) of the tunable filter with a fixed frequency of a particular optical data signal.

The transceiver 100 is configured, in transmitting, to combine a data signal operating at high data rate with a low speed overlay signal. The high speed data signal is an optical data signal, in which an optical carrier carries data in an optical channel. The low speed overlay signal carries only a small amount of data. In particular, the overlay signal only indicates, or carries only information which indicates, a frequency of the optical data channel. In some examples, the overlay signal is carried by the same data signal for which the overlay signal is indicating the frequency. References to data signal may refer to one or more data signals, e.g. at different frequencies. In some examples, the different frequencies of the data signal form a WDM or DWDM optical signal. References to an overlay signal may refer one or more overlay signals, corresponding to one or more data signals.

As pointed out above, currently known techniques that involve the use of fixed optical filters (such as the arrangement illustrated in FIG. 1) require manual connections or are based on tunable filters that are managed by a Network Manager to set the centre wavelength of the channels. The optical networks using these kinds of techniques do not involve self-configuration, since they require specific manual cabling of optical patch cords from optical transceivers to specific filter ports, or require a Network Manager for the network which can configure the wavelength(s) accordingly.

Evolved optical networks may be based on self-tuning optical transceivers. Currently on the market there are Small Form-Factor Pluggable (SFP) transceivers that implement the message channel as out-of-band low speed overlay signal (e.g. similar to G.Metro/ITU-T G.698.4). By using this out-of-band signalling, these SFP transceivers handshake through proprietary protocol the wavelength to tune their tunable laser and a respective remote laser.

Embodiments described herein relates to providing a self-configuring Dense Wavelength Division Multiplexing (DWDM), or WDM, optical network through use of self-configuring tunable optical filters that, once connected to the optical network, do not require intervention of the installer or the operator through a network manager. The proposed technique therefore overcomes the technical problem associated with current optical systems where an optical path cannot be established unless optical connection through optical filters are set up appropriately (by tuning at the appropriate wavelengths and setting up optical cabling correctly) at the start of the process.

According to embodiments described herein, the proposed technique is based on use of fixed DWDM SFP transceivers with out-of-band low speed overlay signalling, one or more tunable optical filters cascaded to an optical photodetector at a transmitting-side, and one or more tunable optical filters cascaded to an optical photodetector at a receiving-side. The structure that includes a tunable optical filter with a photodetector at the front is the same on both the transmitting-side and the receiving-side. The photodetector can detect the modulating signal of the low speed signal overlay. Such signal is used to drive the tunable optical filter at the transmitting-side in order to set the tunable optical filter at the appropriate wavelength. The information relating to the wavelength can be coded in the frequency of the modulating tone of the low speed signalling (where there is a different frequency for each wavelength of the SFP transceiver) or coded in information provided in the low speed channel of the overlay signal. Any reference to DWDM may alternatively be considered as WDM.

Embodiments described in the present disclosure allow optical filters self-tuning capabilities with requiring external commend from a management system. More specifically, embodiments described herein allow optical filters to self-tune at the appropriate wavelength at a local site and at a remote site, independent of cabling between the transceiver and the optical filter. Thus, the technique is human error proof and saves operating expenses (as it does not require multiple visits in the same site to troubleshoot misconnection issues occurring during the installation). Furthermore, tunable optical filers is a currently emerging technology, and thanks to the optical integration in silicon photonics, this technology will provide important cost savings for large production volumes. The technique proposed in the embodiments herein improves network flexibility by allowing connections to certain selected remote equipment without requiring any changes to the optical cabling.

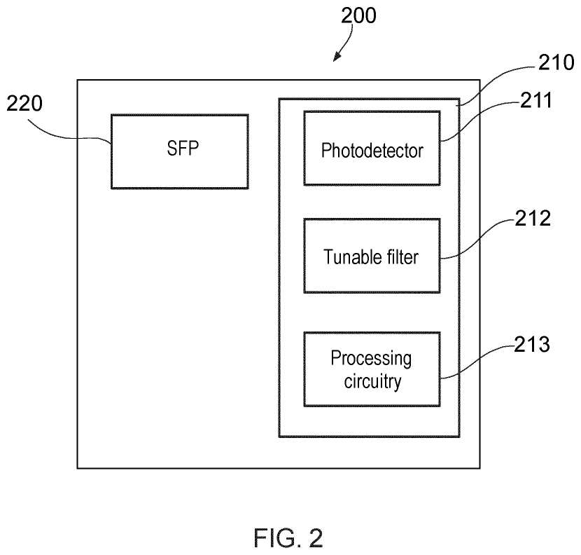

FIG. 2 is a block diagram of a main unit according to embodiments of the disclosure. The main unit 200 according to this embodiment includes an optical filter module 210 and a Small Form-Factor Pluggable (SFP) transceiver 220 inserted in a node host unit (the node host unit not depicted in FIG. 2). The optical filter module 210 comprises a photodetector 211 (such as a photodiode), a transmitting-side tunable optical filter 212, and processing circuitry 213. The photodetector 211 is located at the front in the configuration of the optical filter module 210. In some embodiments, a different type of transceiver may be used instead of the SFP transceiver.

The SFP transceiver 220 (which may be in some cases referred to as a “transmitting-side SFP transceiver”) is configured to enable out-of-band low speed overlay signalling. Furthermore, the SFP transceiver 220 is of a fixed wavelength, and is configured to transmit a low speed overlay signal which can be received by the photodetector 211. In some embodiments, the SFP transceiver 220 may be, more specifically, a fixed Dense Wavelength Division Multiplexing (DWDM) SFP transceiver. In the present application, the transceivers are configured to operate at a pre-determined, or fixed, frequency.

As mentioned above, the photodetector 211 is configured to receive the low speed overlay signal from the SFP transceiver 220. The photodetector 211 and transceiver 220 are co-located, i.e. at the same site.

The processing circuitry 213 is configured to decode information relating to the fixed wavelength from the low speed overlay signal, and to set the transmitting-side tunable optical filter 212 at the fixed wavelength. This information relating to the fixed wavelength may be coded in the frequency of the low speed overlay signal or coded in digital or coded in digital information provided in the low speed channel of the overlay signal.

It will be appreciated that FIG. 2 only shows the components required to illustrate an aspect of the main unit 200 and, in a practical implementation, the main unit 200 may comprise alternative or additional components to those shown.

As another example, in some embodiments, the main unit 200 may comprise a plurality of main optical filter modules 210, each main optical filter module comprises a respective photodetector, a transmitting-side tunable optical filter, and processing circuitry. In these embodiments, the main unit may also comprise a plurality of SFP transceivers, and each of the plurality of SFP transceivers may be of a respective fixed wavelength and corresponds to a respective one of the plurality of optical filter modules. Accordingly, the photodetector at each respective optical filter module may be configured to receive a low speed overlay signal from a respective SFP transceiver.

It will also be appreciated that although FIG. 2 shows the optical filter module as a component of the main unit, in some embodiments of the present disclosure there may be provided an optical filter module on its own instead of being a part of a main unit. FIG. 2 may alternatively be considered as a transmitting side, and may be part of a main unit or a remote unit.

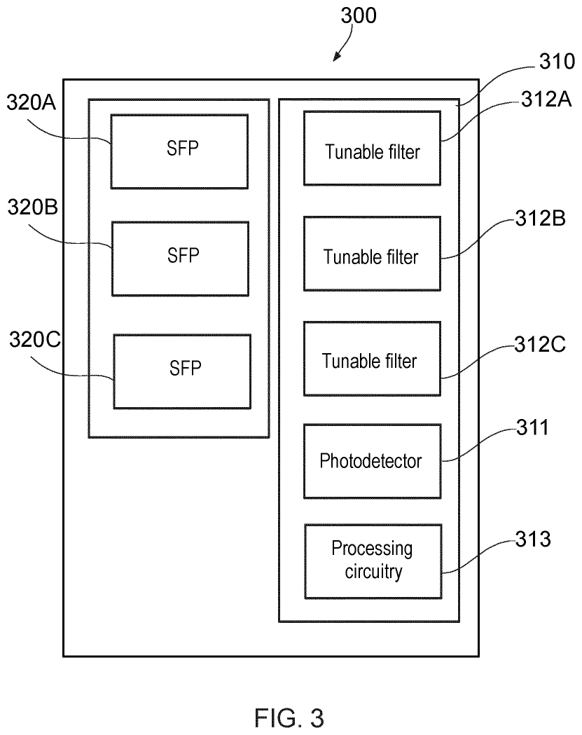

FIG. 3 is a block diagram of a remote unit according to embodiments of the disclosure. The remote unit 300 according to this embodiment comprises an optical filter module 310 and a set of receiving-side tunable optical filters 320A, 320B, and 320C. The optical module 310 comprises a photodetector 311 (such as a photodiode), a first receiving-side tunable optical filter 312A, a second receiving-side tunable optical filter 312B, a third receiving-side tunable optical filter 312C, and processing circuitry 313. The photodetector 311 is located at the front in the configuration of the optical filter module 310.

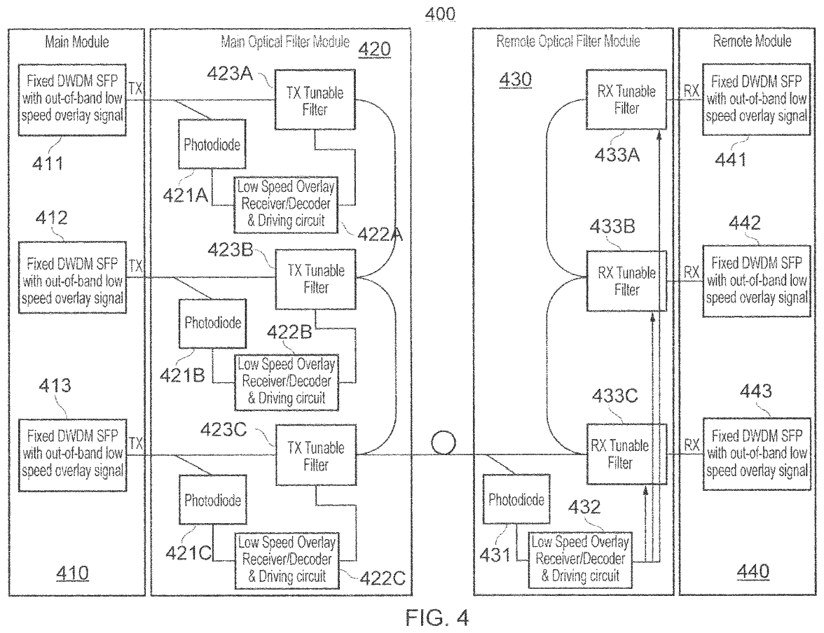

The photodetector 311 is configured to receive a low speed overlay signal. This low speed overlay signal may be received from a transmitting-side SFP transceiver (such as the SFP transceiver 220 illustrated in FIG. 2). More specifically, in some embodiments the low speed overlay signal may be part of a multi-channel aggregate signal, i.e. the aggregate of signals from multiple transmitting-side SFP transceivers in a main unit (such as the multiple transmitting-side SFP transceivers in the main module 410 as illustrated in FIG. 4). The multi-channel aggregate signal may be considered as the WDM plurality of data signals at different frequencies, including one or more overlay signal(s) as described. FIG. 3 may alternatively be considered as located at a receiving side, and may be part of a main unit or a remote unit.

The overlay signal indicates the wavelength of the optical data signal, i.e. the frequency/wavelength of the optical transceiver. This wavelength is fixed, i.e. not intended to be tuned or changed during normal operation. Information relating to a fixed wavelength may be coded in the frequency of the low speed overlay signal, or coded in digital information exchanged in a channel through which the low speed overlay signal is received. For example, the frequency of the overlay signal may indicate the wavelength of the data signal using a look-up table, with each possible frequency of the overlay signal corresponding to a wavelength of the data signal. Alternatively, the overlay signal is a modulated signal, the modulation indicating data bits. The data bits indicate a value which, e.g. via a look-up table, corresponds to the wavelength of the data signal.

In embodiments where the photodetector 311 receives a multichannel aggregate signal, the photodetector 311 may optically split the received signal and extract the low speed overlay signal. In some embodiments, the low speed overlay signal may be a time division low speed overlay signal or a frequency division low speed overlay signal.

In the case where the low speed overlay signal is a time division low speed overlay signal, the photodetector 311 may receive one overlay signal at a time as the optical communication system may follow an algorithm in which only one SFP transceiver enables its low speed overlay at a time. As such, only one overlay signal is transmitted at any one time. After the overlay signal is transmitted, a further overlay signal is transmitted. The consecutively transmitted overlay signals, corresponding to each of the data signals (e.g. in a pre-determined pattern), may use the same frequency.

In the case where the low speed overlay signal is a frequency division low speed overlay signal, each overlay signal associated with a respective SFP transceiver has a low speed carrier at a respective different frequency for a respective different wavelength, and accordingly the photodetector 311 may receive multiple different overlay signals at the same time. In this case, the plurality of overlay signals may be transmitted concurrently, i.e. at the same time. The photodetector and processing circuitry is configured to separate the different overlay signals, e.g. using signal processing.

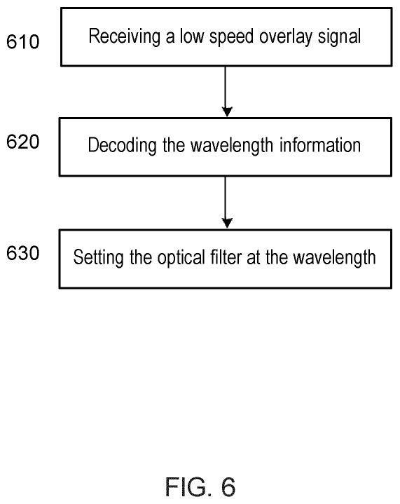

The processing circuitry 313 is configured to decode the information relating to the fixed wavelength from the low speed overlay signal, and to set a respective receiving-side tunable optical filter 312 at the fixed wavelength so as to enable the receiving-side tunable optical filter 312 to operate. As mentioned above in some embodiments the photodetector 311 may receive one overlay signal at a time, and in these embodiments, the driving circuitry 313 may decode the information relating to a fixed wavelength from a respective low speed overlay signal, and to set a respective receiving-side tunable optical filter 312 at the respective fixed wavelength. In some embodiments, the setting of wavelengths at respective receiving-side tunable optical filters may be performed in a sequential manner, as will be explained in more detail with reference to FIGS. 6 to 8. Moreover, further details relating to setting respective receiving-side tunable optical filters 312 will be explained in more detail with reference to the flowcharts in FIGS. 6 to 8.

The set of SFP transceivers includes a first SFP transceiver 320A, a second SFP transceiver 320B, and a third SFP transceiver 320C. Each of the first to third SFP transceivers 320A, 320B, 320C of the present embodiment corresponds to a respective receiving-side tunable optical filter 312A, 312B, 312C. More specifically, in this embodiment, the first SFP transceiver 320A corresponds to the first receiving-side tunable optical filter 312A, the second SFP transceiver 320B corresponds to the second receiving-side tunable optical filter 312B, and the third SFP transceiver 320C corresponds to the third receiving-side tunable optical filter 312C. In some embodiments, each of the first to third SFP transceivers 320A, 320B, 320C may be a fixed Dense Wavelength Division Multiplexing (DWDM) SFP transceiver.

Although it is shown in FIG. 3 that the optical module 310 comprises the first receiving-side tunable optical filter 312A, the second receiving-side tunable optical filter 312B, the third receiving-side tunable optical filter 312C, it will be appreciated that in some embodiments the optical filter module 310 may comprise more or fewer receiving-side tunable optical filters. Moreover, in these embodiments, the set of SFP transceivers in the remote unit 300 may comprise more or fewer SFP transceivers, to correspond with the number of receiving-side tunable optical filters.

It will be appreciated that FIG. 3 only shows the components required to illustrate an aspect of the remote unit 300 and, in a practical implementation, the remote unit 300 may comprise alternative or additional components to those shown.

FIG. 4 is a block diagram of an optical communication system according to embodiments of the disclosure. The optical communication system 400 illustrated in FIG. 4 may form a part of a self-configuring (Dense) Wavelength Division Multiplexing ((D) WDM) optical network, where the self-configuring aspect is achieved by the self-tuning capabilities of at least some of the components of the optical communication system described herein. It is noted that FIG. 4 only illustrates one-way direction aspect of the optical communication system. In some aspects, the remote module also comprises transmission capability, and a transmission optical filter module 420. Similarly, the main unit/module may also be configured to receive data signals and one more overlay signals from the remote unit/module. For simplicity, FIG. 4 only shows one-way transmission from the main unit to the remote unit.

The optical communication system according to this embodiment includes a main module 410, a main optical filter module 420, a remote optical filter module 430, and a remote module 440. The main module 410 comprises a first transmitting-side SFP transceiver 411, a second transmitting-side SFP transceiver 412, and a third transmitting-side SFP transceiver 413. These transmitting-side SFP transceivers may be fixed DWDM SFP transceivers, and it will also be appreciated that other types of transceivers may be used instead of SFP transceivers. The transceivers 411,412,413 are configured to transmit a combined data signal and overlay signal.

The main optical filter module 420 comprises a first photodetector 421A, a second photodetector 421B, and a third photodetector 421C. Furthermore, the main optical filter module 420 comprises a first processing circuitry 422A, a second processing circuitry 422B, and a third processing circuitry 422C. Each of the first, second, and third processing circuitries includes a low speed overlay receiver/decoder and a driving circuit. The main optical filter module 420 further comprises a first transmitting-side tunable optical filter 423A, a second transmitting-side tunable optical filter 423B, and a third transmitting-side tunable optical filter 423C. The main module 410 and the main optical filter module 420 may be considered as components of a main unit (such as the one illustrated in FIG. 2).

The first photodetector 421A, the first processing circuitry 422A, and the first transmitting-side tunable optical filter 423A correspond to the first transmitting-side SFP transceiver 411 at the main module 410. Similarly, the second photodetector 421B, the second processing circuitry 422B, and the second transmitting-side tunable optical filter 423B correspond to the second transmitting-side SFP transceiver 412 at the main module 410, and the third photodetector 421C, the third processing circuitry 422C, and the third transmitting-side tunable optical filter 423C correspond to the third transmitting-side SFP transceiver 413 at the main module 410.

In the present embodiment, each of the first transmitting-side SFP transceiver 411, the second transmitting-side SFP transceiver 412, and the third transmitting-side SFP transceiver 413 is configured to enable an overlay channel while respective overlay channels at other transmitting-side SFP transceivers are disabled. For example, when the overlay channel at the first transmitting-side SFP transceiver 411 is enabled, the respective overlay channels at the second transmitting-side SFP transceiver 412 and the third transmitting-side SFP transceiver 413 are disabled. In this example, the overlay signals are time division multiplexed, as described above.

Each of the first photodetector 421A, a second photodetector 421B, and a third photodetector 421C at the main optical filter module 420 is configured to receive a low speed overlay signal from corresponding transmitting-side SFP transceivers. As such, each SFP transceiver (as a transmitter) is associated with a particular one of the TX tunable filters 422A, 422B, 422C. The TX tunable filters 422A, 422B, 422C are tuned, using the information contained in the overlay signals, to the frequency channel of the SFP transmitter in the main module, which is transmitting the data signal. Information relating to fixed wavelength of the SFP transceiver may be coded in the frequency of the low speed overlay signal or coded in digital information exchanged in a corresponding overlay channel.

Accordingly, in the present embodiment, the first photodetector 421A is configured to receive a low speed overlay signal from the first transmitting-side SFP transceiver 411, the second photodetector 421B is configured to receive a low speed overlay signal from the second transmitting-side SFP transceiver 412, and the third photodetector 421C is configured to receive a low speed overlay signal from the third transmitting-side SFP transceiver 413. In some examples, he first photodetector 421A, a second photodetector 421B, and a third photodetector 421C may be configured to receive respective low speed overlay signals sequentially.

Each of the first processing circuitry 422A, the second processing circuitry 422B, and the third processing circuitry 422C is configured to decode information relating to the corresponding fixed wavelength from the respective low speed overlay signal and to set a corresponding transmitting-side tunable optical filter at the corresponding fixed wavelength. For example, the first processing circuitry 422A is configured to decode the information relating to the fixed wavelength of the first transmitting-side SFP transceiver, and to set the first transmitting-side tunable optical filter 423A at the fixed wavelength. The similar operation may be performed at the second processing circuitry 422B to set the second transmitting-side tunable optical filter 423B at the corresponding fixed wavelength, and at the third processing circuitry 422C to set the third transmitting-side tunable optical filter 423C at the corresponding fixed wavelength.

The remote optical filter module 430, at a location remote from the main module 410/main optical filter module 420, comprises a photodetector 431, a processing circuitry 432, a first receiving-side tunable optical filter 433A, a second receiving-side tunable optical filter 433B, and a third receiving-side tunable optical filter 433C. The remote module 440 comprises a first receiving-side SFP transceiver 441, a second receiving-side SFP transceiver 442, and a third receiving-side SFP transceiver 443. It will be appreciated that other types of transceivers may be used instead of SFP transceivers in the remote module 430. The remote module 430 and the remote optical filter module 440 may be considered as components of a remote unit (such as the one illustrated in FIG. 3).

The first receiving-side tunable optical filter 433A corresponds to the first receiving-side SFP transceiver 441 at the remote module 440. Similarly, the second receiving-side tunable optical filter 433B corresponds to the second receiving-side SFP transceiver 442 at the remote module 440, and the third receiving-side tunable optical filter 433C correspond to the third receiving-side SFP transceiver 443 at the remote module 440.

Moreover, the first receiving-side SFP transceiver 441 corresponds to the first transmitting-side SFP transceiver 411, the second receiving-side SFP transceiver 442 corresponds to the second transmitting-side SFP transceiver 412, and the third receiving-side SFP transceiver 443 corresponds to the third transmitting-side SFP transceiver 413.

The photodetector 431 of the remote optical filter module 430 is configured to receive one or more low speed overlay signals. The processing circuitry 432 (comprising a low speed overlay receiver/decoder and a driving circuit) is configured to decode the information relating to the corresponding fixed wavelength from the low speed overlay signal, and to set (i.e. drive) a receiving-side tunable optical filter corresponding to the respective transmitting-side SFP transceiver at the corresponding fixed wavelength. For example, the processing circuitry 432 may be configured to set the first receiving-side tunable optical filter 433A at the fixed wavelength of the first transmitting-side SFP transceiver by decoding relevant information relating to the wavelength in the respective low speed overlay signal. The processing circuitry 432 can perform the same operation to set the second receiving-side tunable optical filter 433B and the third receiving-side tunable optical filter 433C at respective wavelengths corresponding to the received data channel.

Once a receiving-side tunable optical filter is set at the corresponding wavelength, the receiving-side SFP transceiver corresponding to that optical filter can establish a connection with a corresponding transmitting-side SFP transceiver. In this embodiment, the first receiving-side SFP transceiver 441 can be connected to the first transmitting-side SFP transceiver 411, the second receiving-side SFP transceiver 442 can be connected to the second transmitting-side SFP transceiver 412, and the third receiving-side SFP transceiver 443 can be connected to the third transmitting-side SFP transceiver 413.

The technique proposed in the present disclosure allows optical filters to be self-tuned by exploiting a photodetector located in front of the optical filter. It can be seen in FIG. 4 that the tunable optical filters are not managed by the main unit (the main module) or the remote unit (remote module), or by a network management system.

It will be appreciated that FIG. 4 only shows the components required to illustrate an aspect of the optical communication system and, in a practical implementation, the optical communication system may comprise alternative or additional components to those shown. For example, in some embodiments DWDM SFP tunable lasers may be used in place of the transmitting-side tunable optical filters in the main optical filter module.

As another example, even though FIG. 4 only shows the remote optical filter module comprising a single photodetector, in alternative embodiments the remote optical filter module may comprise a plurality of photodetectors, where each of the plurality of photodetectors corresponds to a respective one of the receiving-side tunable optical filers.

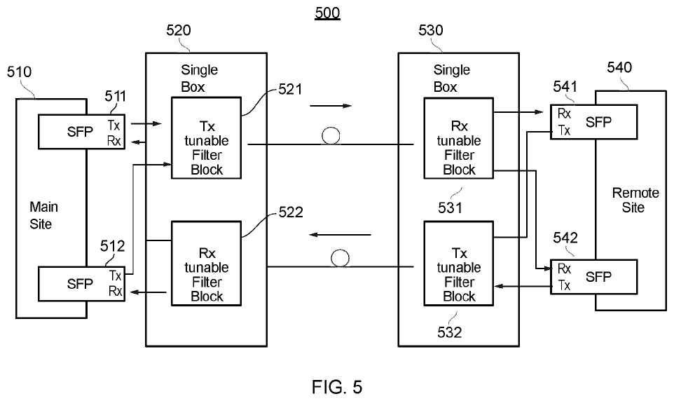

FIG. 5 is a block diagram of an optical communication system according to embodiments of the disclosure. The optical communication system 500 illustrated in FIG. 5 may form a part of a self-configuring Dense Wavelength Division Multiplexing (DWDM) optical network, where the self-configuring aspect is achieved by the self-tuning capabilities of at least some of the components of the optical communication system described herein. It is noted that FIG. 5 illustrates a bidirectional aspect of the optical communication system. In other words, FIG. 5 illustrates a bidirectional system which may be regarded as a configuration in which the arrangement of FIG. 4 is implemented for both the main-to-remote direction and the remote-to-main direction.

The optical communication system according to this embodiment includes a first SFP transceiver 511 and a second SFP transceiver 512 located at a main site 510, a first transmitting-side tunable filter block 521 and a first receiving-side tunable filter block 522 located in at a first filter module 520, a second receiving-side tunable filter block 531 and a second transmitting-side tunable filter block 532 at a second filter module 530, and a third SFP transceiver 541 and a fourth SFP transceiver 542 located at a remote site 540.

Each of the first transmitting-side tunable filter block 521 and second transmitting-side tunable filter block 532 may include a plurality of transmitting-side tunable optical filters, corresponding photodetectors, and corresponding processing circuitries. Similarly, each of the first receiving-side tunable filter block 522 and second receiving-side tunable filter block 531 may include a plurality of receiving-side tunable optical filters, corresponding photodetector(s), and corresponding processing circuitry (or circuitries). The functions of the optical filters, photodetectors, and processing circuitries are similar to those as described with reference to FIG. 4 and therefore will not be repeated here. In the present embodiment, the first, second, third, and fourth SFP transceivers are configured to transmit and receive data signals, and transmit low speed overlay signals, to be used to configure tunable optical filters at both the transmitting node and the receiving node.

FIG. 6 is a flowchart illustrating a method for enabling self-tuning at an optical filter module according to embodiments of the disclosure. The illustrated method can generally be performed by or under the control of an optical filter module, such as the optical filter module described with reference to FIG. 2. The optical filter module comprises a photodetector, a tunable optical filter (transmitting-side and/or receiving-side), and processing circuitry. To facilitate understanding of the present embodiment, the method of FIG. 6 will be explained with reference to the components of the main unit of FIG. 2.

With reference to FIG. 6, the method begins with step 610 at which the photodetector 211 of the optical filter module 210 receives a low speed overlay signal from a transceiver (such as a SFP transceiver) of a fixed wavelength, or more generally, a pluggable optical module. For example, this overlay signal may be received from the SFP transceiver 220 at the main unit 200. Information relating to the fixed wavelength may be coded in the frequency of the low speed overlay signal or coded in digital information exchanged in a low speed channel through which the low speed overlay signal is received.

Subsequently, at step 620, the processing circuitry 213 decodes the information relating to the fixed wavelength from the low speed overlay signal; at step 630, the processing circuitry 213 controls (drives) tunable optical filter to operate at the signalled fixed wavelength.

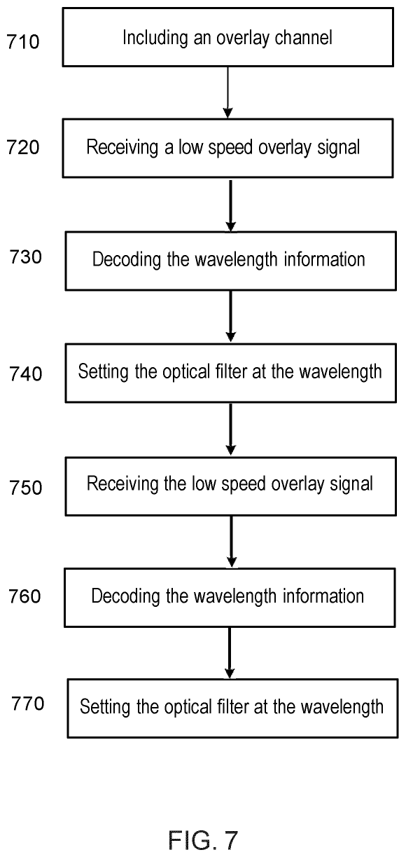

FIG. 7 is a flowchart illustrating a method for enabling self-tuning at an optical communication system according to embodiments of the disclosure. The illustrated method can generally be performed by or under the control of an optical communication system, such as the optical communication system described with reference to FIG. 4. The optical communication system comprises a main unit and a remote unit.

In the present embodiment, the main unit comprises a plurality of transmitting-side SFP transceivers each of a fixed wavelength, a plurality of transmitting-side tunable optical filters each corresponding to a transmitting-side SFP transceiver, a plurality of photodetectors each corresponding to a transmitting-side SFP transceiver, and a plurality of processing circuitries each corresponding to a transmitting-side tunable optical filter. The remote unit comprises a plurality of receiving-side SFP transceivers each corresponding to a transmitting-side SFP transceiver of the main unit, a plurality of receiving-side tunable optical filters each corresponding to a receiving-side SFP transceiver, a photodetector, and a processing circuitry. To facilitate understanding of the present embodiment, the method of FIG. 7 will be explained with reference to the components of the optical communication system of FIG. 4.

The method begins at step 710, at which the first transmitting-side SFP transceiver 411 (of the plurality of transmitting-side SFP transceivers of the main unit) includes an overlay channel for transmission of information about the wavelength, and optionally port information. Overlay channels at other transmitting-side SFP transceivers (such as the second transmitting-side SFP transceiver 412 and the third transmitting-side SFP transceiver 413) are disabled, i.e. only one overlay signal is used at any one time As such, the overlay signals are time division multiplexed.

Then, at step 720, the first photodetector 421A (which corresponds to the first transmitting-side SFP transceiver 411) receives a low speed overlay signal from the first transmitting-side SFP transceiver.

Information relating to a corresponding fixed wavelength may be coded in the frequency of the low speed overlay signal, or coded in digital information provided in the low speed channel of the overlay signal. In some embodiments, the low speed overlay signal may include at least one of: information relating to the fixed wavelength, information relating to port number of the remote unit, and information relating to a last filter port tried number or a progressive number indicative of a number of attempts to establish connection between the main unit and the remote unit.

At steps 730 and 740, the first processing circuitry 422A of the main unit (which corresponds to the first transmitting-side tunable optical filter and the first photodetector 421A) decodes information relating to the fixed wavelength from the low speed overlay signal, and sets the first transmitting-side tunable optical filter 423A at the corresponding fixed wavelength.

At step 750, the photodetector 431 of the remote unit receives the low speed overlay signal. Then, at steps 760 and 770, the processing circuitry 432 of the remote unit decodes the information relating to the fixed wavelength from the low speed overlay signal, and sets the first receiving-side tunable optical filter 433A at the fixed wavelength.

As mentioned above, in some embodiments the low speed overlay signal may include a last filter port tried number or a progressive number indicative of a number of attempts to establish connection between the main unit and the remote unit, In these embodiments, at step 770 the processing circuitry 432 of the remote unit may be configured to set the first receiving-side tunable optical filter 433A at the fixed wavelength based on the last filter port tried number or the progressive number.

It will be appreciated that the above-described steps can be performed in a similar manner to set the second transmitting-side tunable optical filter 423B and the second receiving-side optical filter 433B the respective wavelength (of the second transmitting-side SFP transceiver), and to set the third transmitting-side tunable optical filter 423C and the third receiving-side tunable optical filter 433C at the respective wavelength (of the third transmitting-side SFP transceiver). The steps can also be further repeated for the rest of the transmitting-side tunable optical filters and the rest of the receiving-side tunable optical filters.

Moreover, it will be appreciated that in some embodiments tuning (setting the wavelength) of the tunable optical filters are performed sequentially, e.g. once the connection is established between the first transmitting-side SFP transceiver 411 and the first receiving-side SFP transceiver 441, the above-describe steps are to be performed similarly to set the respective wavelength at the second transmitting-side tunable optical filter and the second receiving-side tunable optical filter, starting with the second transmitting-side SFP transceiver 412 (of the plurality of transmitting-side SFP transceivers of the main unit) enables an overlay channel for transmission while keeping respective overlay channels at other transmitting-side SFP transceivers (such as the first transmitting-side SFP transceiver 411 and the third transmitting-side SFP transceiver 413) disabled. In some examples, the filters for one wavelength/transmitter are set one at a time, and further filters are set only once the filters for the first wavelength of data signals are configured (tuned).

In a further aspect, the low speed overlay signal may include information relating to a port number of the remote unit to which the main unit SFP is to be connected. This port number is provided by a host to the respective transmitting-side SFP transceiver. In this embodiment, setting the first receiving-side tunable optical filter at the corresponding fixed wavelength and establishing a connection between the first transmitting-side SFP transceiver 411 and the first receiving-side SFP transceiver 441 are only performed if the port number indicated by the lower speed overlay signal corresponds to a port number at the receiving-side SFP transceiver.

In this example, the low speed overlay signal (from the first transmitting-side SFP transceiver 411) may include information relating to a filter port try number or a progressive number. This information is used by the receiver to initially set a first tunable filter 433A in the receiver (or the remote optical filter module 430) to the signalled wavelength. At the receiver (or the remote module 440), the remote SFP reads the information of the port number where the main SFP is to be connected. If the port number inside the overlay signal is the same of the port number inside the SFP (the host board provides only this port number to the SFP) then the remote SFP turns on its laser and the optical connection is established. If the port number of the SFP inside the overlay is different from the one stored in the remote SFP, than the remote SFP keeps its laser turned off. In this way, a timeout expires and the main site SFP turns off its laser and restarts the procedure, i.e. turning on the laser and transmitting a modified overlay signal. In this subsequent overlay signal, the receiver/remote site photodetector receives the overlay signal with the information of the wavelength and a modified progressive number or port try number that is detected by the processing circuitry 432 to drive a different receiver tunable filter, as indicated in the overlay signal, e.g. a second tunable filter 433B. Now the remote SFP reads the port number for which a connection is required from the overlay. The method above repeats, i.e. if the port number in the overlay matches the SFP number inside the port, then the connection is made. If the SFP port number is different, the port try number or progressive number indicating a receiver tunable filter to connect to is modified (e.g. incremented). This allows the transmitter to try different receiver tunable filters to connect to the required receiver transceiver. In particular, this method accounts for misconnections between the tunable filters and transceivers. The transmitter (main unit) knows the port number of the transceiver for which a connection is required, and includes this in the overlay signal. However, this port number may not be connected to the correct tunable filter. Hence, if the transceiver detects that the received port number in the overlay signal does not match its own port number, this may indicate a misconnection. The method modifies the port try number or progressive number to connect the transmitted signal to different tunable filters, on the basis that the different tunable filter may actually be connected to the correct transceiver i.e. having the signalled port number.

In this embodiment, the method may further comprise increasing the filter port try number or the progressive number if a connection is not established between the first transmitting-side SFP transceiver and the first receiving-side SFP transceiver. The increasing of the filter port try number or the progressive number may be performed after expiry of a predetermined timeout period. In these embodiments, subsequent to increasing the filter port try number or the progressive number, the steps illustrated in FIG. 7 may be repeated for the first transmitting-side SFP transceiver 411and the first receiving-side SFP transceiver 441 in attempt to allow these components to establish a connection.

The method may comprise, subsequent to setting the first transmitting-side tunable optical filter and the first receiving-side tunable topical filter at the fixed wavelength, establishing a connection between the first transmitting-side SFP transceiver 411 and a first receiving-side SFP transceiver 441.

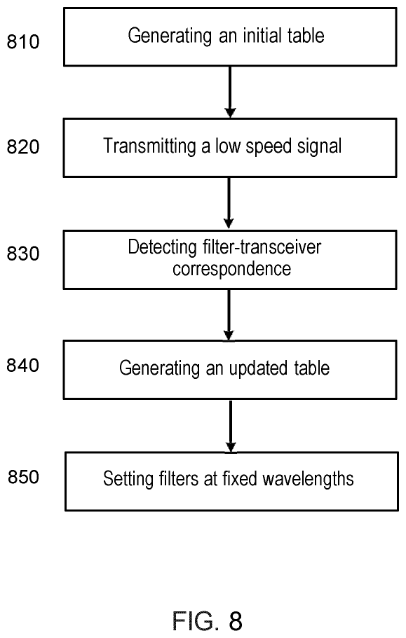

FIG. 8 is a flowchart illustrating a method for enabling self-tuning at an optical communication system according to embodiments of the disclosure. The illustrated method can generally be performed by or under the control of an optical communication system, such as the optical communication system described with reference to FIG. 4 or 5. The optical communication system comprises a main unit (e.g. main site 510) and a remote unit (e.g. remote site 540).

In the present embodiment, and with reference to FIG. 5, the main unit comprises a main host unit comprising a plurality of transceivers. The main site further comprises a first filter module 520 comprising a first transmitting-side tunable filter block 521 and a first receiving-side tunable filter block 522. A remote site comprises a remote host unit comprising a plurality of transceivers. The remote site further comprises a second filter module 530 comprising a second receiving-side tunable filter block 531 and a second transmitting-side tunable filter block 532.

The filter blocks comprise one or more photodetector, as described above, for detecting an overlay signal comprising information about the data signal.

The remote site, e.g. the second filter module 530 may comprise processing circuitry to control or carry out these steps. Similarly, the main site, e.g. first filter module, may comprise processing circuitry to control or carry out corresponding steps.

In one example, the second transmitting-side tunable filter block 532 receives an overlay signal including information which identifies the data signal being transmitted. The information comprises one or more of: transceiver identifier (e.g. SFP number), channel wavelength and filter port for transmission. In some examples, the filter port for transmission is determined by the second transmitting-side tunable filter block 532, and is not from the overlay signal. This information may be considered as cross-connections for each of the data channels. The second transmitting-side tunable filter block 532 can be considered as generating a table, in step 810, of the cross-connection information.

The cross-connection information is transmitted from the second transmitting-side tunable filter block 532 to the second receiving-side tunable filter block 531. As such, the cross-connection information is transmitted internally within the remote site. In some examples, the cross-connection information may be transmitted as the overlay signal, or as another low speed signal, in step 820. In this case, the overlay signal may be detected by a photodetector of the second receiving-side tunable filter block 531.

The second receiving-side tunable filter block 531 receives an overlay signal from the main site, using a photodetector as described above. The overlay signal comprises the transceiver identifier (e.g. SFP number) for the intended transceiver in the remote site. The second receiving-side tunable filter block 531 is configured to determine, from the cross-connection information (i.e. table), the wavelength and filter port to use to send the associated received data channel to the correct transceiver, in step 830. The second receiving-side tunable filter block 531 is tuned to the correct wavelength and port which connects to the identified SFP, in step 850. In 840, the table may be updated with further cross-connection information.

A corresponding process may be carried out at the main site, with cross-connection information being transferred within the first filter module 520, i.e. from the first transmitting-side tunable filter block 521 to the first receiving-side tunable filter block 522.

The method, for example as illustrated in FIG. 8, allow optical connections to be established in a simplified way so as to avoid errors such as wrong connections and multiple iterations/visits in field by the operators, as the optical link is achieved through patch cords between a transceiver and an optical filter may be easily misconnected. With the method, e.g. as illustrated in FIG. 8, a transceiver can just be connected to an optical filter and the technique allow automatic adjustment and re-routing to the right channel on the right port. This is different currently known technique which are based on the use of fixed optical filters, where a fibre misconnection cannot be fixed automatically and would require intervention from the operator/installer, e.g. going in field to fix the misconnection. There is provided two degrees of freedom as rerouting can be performed at two different points (i.e. at a transmitting-side tunable optical filter and at a receiving-side tunable optical filter).

It will be appreciated that although the steps in the methods illustrated in FIGS. 6 to 8 have been described as being performed sequentially, in some embodiments at least some of the steps in the illustrated method may be performed in a different order, and/or at least some of the steps in the illustrated method may be performed simultaneously. Moreover, in some embodiments the methods illustrated in FIGS. 6 to 8 may be performed multiple times to set multiple optical filters at respective wavelengths. For example, the method illustrated in FIG. 6 may be performed so as to set a first receiving-side tunable optical filter at a respective appropriate wavelength, and subsequently the method illustrated in FIG. 6 may be performed again so as to set a second receiving-side tunable optical filter at a respective (different) appropriate wavelength.

Examples of the description have been described as using a SFP. Other formats of transceiver may alternatively be used, and the examples are not limited to SFP format. Some examples refer to a transceiver. References to transceiver may be replaced by a reference to a transmitter (e.g. in the main module 410/main site) or a receiver (e.g. in the remote module 440/remote site).

Any appropriate steps, methods, or functions may be performed through a computer program product that may, for example, be executed by the components and equipment illustrated in the figure above. For example, in some embodiments there may be provided a storage or a memory at the optical communication system that may comprise non-transitory computer readable means on which a computer program can be stored. The computer program may include instructions which cause processing circuitry (and/or any operatively coupled entities and devices) to execute methods according to embodiments described herein. The computer program and/or computer program product may thus provide means for performing any steps herein disclosed.

Embodiments of the disclosure thus introduce components of an optical communication system and methods for enabling self-tuning of optical filters in a main optical filter module, or a main unit, or a remote optical filter module, or a remote unit, or in an optical communication system. In more detail, embodiments of the disclosure introduce a mechanism for providing optical filters with self-tuning capabilities so as to prevent the need for specific cabling or intervention/control from a Network Manager.

The above disclosure sets forth specific details, such as particular embodiments or examples for purposes of explanation and not limitation. It will be appreciated by one skilled in the art that other examples may be employed apart from these specific details.

1. An optical filter module comprising a photodetector, a tunable optical filter, and processing circuitry,
wherein the photodetector is configured to receive a low speed overlay signal from a transceiver of a fixed wavelength, and
wherein the processing circuitry is configured to decode information relating to the fixed wavelength from the low speed overlay signal and set the optical filter at the fixed wavelength.

2. The optical filter module according to claim 1, wherein the information relating to the fixed wavelength is coded in the frequency of the low speed overlay signal, or coded in digital information provided in the low speed channel of the overlay signal.

3. The optical filter module according to claim 1, wherein the tunable optical filter is one of a transmitting-side tunable optical filter and a receiving-side tunable optical filter.

4. A main unit for communication with a remote unit in an optical communication system, the main unit comprising:
one or more optical filter modules according to claim 1, wherein each of the one or more optical filter modules includes a transmitting-side tunable optical filter; and
one or more transceivers, wherein each of the one or more transceivers is of a fixed wavelength, and each of the one or more transceivers corresponds to a respective optical filter module.

5. A method for enabling self-tuning at an optical filter module, wherein the optical filter module comprises a photodetector, a tunable optical filter, and processing circuitry, the method comprising:
receiving, by the photodetector, a low speed overlay signal from a transceiver of a fixed wavelength;
decoding, by the processing circuitry, information relating to the fixed wavelength from the low speed overlay signal; and
setting, by the processing circuitry, the tunable optical filter at the fixed wavelength.

6. A remote unit for communication with a main unit in an optical communication system, the remote unit comprising:
one or more receiving-side tunable optical filters;
one or more transceivers, wherein each of the one or more transceivers is of a fixed wavelength, and each of the one or more transceivers corresponds to a respective receiving-side tunable optical filter; and
a photodetector configured to receive a low speed overlay signal; and processing circuitry configured to decode information relating to the fixed wavelength from the low speed overlay signal and set the one or more receiving-side tunable optical filters at the fixed wavelength.

7. An optical communication system comprising:
a main unit comprising:
a plurality of transmitting-side transceivers, wherein each transmitting-side transceiver is of a fixed wavelength and is configured to enable an overlay channel while respective overlay channels at other transmitting-side transceivers are disabled;
a plurality of transmitting-side tunable optical filters each corresponding to a transmitting-side transceiver;
a plurality of photodetectors each corresponding to a transmitting-side transceiver, wherein each photodetector is configured to receive a low speed overlay signal from a corresponding transmitting-side transceiver; and
a plurality of processing circuitries each corresponding to a transmitting-side tunable optical filter, wherein each processing circuitry is configured to decode information relating to the corresponding fixed wavelength from the low speed overlay signal and to set a corresponding transmitting-side tunable optical filter at the corresponding fixed wavelength,
a remote unit comprising:
a plurality of receiving-side transceivers, wherein each receiving-side transceiver corresponds to a transmitting-side transceiver of the main unit;
a plurality of receiving-side tunable optical filters each corresponding to a receiving-side transceiver;
a photodetector configured to receive one or more low speed overlay signals; and
processing circuitry configured to decode the information relating to the corresponding fixed wavelength from the low speed overlay signal and set a receiving-side tunable optical filter corresponding to the respective transmitting-side transceiver at the corresponding fixed wavelength.

8. A method for enabling self-tuning at an optical communication system,
wherein the optical communication system comprises a main unit and a remote unit,
wherein the main unit comprises a plurality of transmitting-side transceivers each of a fixed wavelength, a plurality of transmitting-side tunable optical filters each corresponding to a transmitting-side transceiver, a plurality of photodetectors each corresponding to a transmitting-side transceiver, and a plurality of processing circuitries each corresponding to a transmitting-side tunable optical filter,
wherein the remote unit comprises a plurality of receiving-side transceivers each corresponding to a transmitting-side transceiver of the main unit, a plurality of receiving-side tunable optical filters each corresponding to a receiving-side transceiver, a photodetector, and a driving circuit;
wherein the method comprises:
including an overlay channel at a first transmitting-side transceiver of the plurality of transmitting-side transceivers for transmission of information about the wavelength, while keeping respective overlay channels at other transmitting-side transceivers disabled;
receiving, at a first photodetector of the main unit which corresponds to the first transmitting-side transceiver, a low speed overlay signal from the first transmitting-side transceiver;
decoding, by a first processing circuitry of the main unit which corresponds to the first transmitting-side tunable optical filter, information relating to the fixed wavelength from the low speed overlay signal;
setting, by the first processing circuitry of the main unit, the first transmitting-side tunable optical filter at the fixed wavelength;
receiving, by the photodetector of the remote unit, the low speed overlay signal;
decoding, by the processing circuitry of the remote unit, information relating to the fixed wavelength from the low speed overlay signal; and
setting, by the processing circuitry of the remote unit, a first receiving-side tunable optical filter at the fixed wavelength.

9. The method according to claim 8, further comprising, subsequent to setting the first transmitting-side tunable optical filter and the first receiving-side tunable topical filter at the fixed wavelength, establishing a connection between the first transmitting-side transceiver and a first receiving-side transceiver.

10. The method according to claim 8, wherein the low speed overlay signal includes at least one of:
information relating to the fixed wavelength;
information relating to port number of the remote unit to which a transmitting-side transceiver is to be connected; and
information relating to a last filter port tried number or a progressive number indicative of a number of attempts to establish connection between the main unit and the remote unit.

11. The method according to claim 10, wherein the low speed overlay signal includes information relating to a port number of the remote unit to which a transmitting-side transceiver is to be connected, and wherein setting the first receiving-side tunable optical filter at the corresponding fixed wavelength and establishing a connection between the first transmitting-side transceiver and the first receiving-side transceiver are only performed if the port number indicated by the lower speed overlay signal corresponds to a port number at the receiving-side transceiver.

12. The method according to claim 10, wherein the low speed overlay signal includes information relating to a filter port try number or a progressive number, and the method further comprises increasing the filter port try number or the progressive number if a connection is not established between the first transmitting-side transceiver and the first receiving-side transceiver.

13. A method for enabling self-tuning at an optical communication system,
wherein the optical communication system comprises a main unit and a remote unit,
wherein the main unit comprises a main host unit and a plurality transceivers each of a fixed wavelength,
wherein the remote unit comprises a remote host unit, a plurality of transceivers, a plurality of receiving-side tunable optical filters, and a processing circuitry;
wherein the method comprises:
generating, in the remote unit, information relating to the cross-connections between a transceiver identifier and filter port for transmission;
transmitting the information relating to the cross-connections to the receiving-side tunable optical filters, and
setting, by the processing circuitry of the remote unit, a receiving-side tunable optical filter at respective wavelength based on the information relating to the cross-connections.
